(19) United States
(12) Patent Application Publication
(10) Pub. No.: US 2012/0234309 A1
(43) Pub. Date: Sep. 20, 2012

(54) FOLDABLE COOKING DEVICE

(76) Inventors: Michael HORITO, Provo, UT (US); Lee Croy, Portland, OR (US); John R. Omdahl, II, Lindon, UT (US); Steven Madsen, Edgewater, NJ (US)

(21) Appl. No.: 13/368,368

(22) Filed: Feb. 8, 2012

Related U.S. Application Data
(60) Provisional application No. 61/440,412, filed on Feb. 8, 2011.

(51) Int. Cl. A47J 33/00

(52) U.S. Cl. 126/25 R

(57) ABSTRACT

The invention relates to a foldable cooking device comprising: a first partial shell (2); a second partial shell (3) pivotably connected to the first partial shell (2) via a hinge (6); a heating unit (8) mounted to an inside (9) of the first partial shell (2); and a lighting unit (14, 14a) for illuminating the heating unit (8) in the unfolded state (US) of the cooking device, the lighting unit (14, 14a) being attached to an inside (15) of the second partial shell (3), wherein the insides (9, 15) of the first partial shell (2) and the second partial shell (3) face each other in the folded state of the cooking device.

### FIELD OF THE INVENTION

The present invention relates to outdoor cooking equipment, more particularly a foldable cooking device such as a grill.

### BACKGROUND OF THE INVENTION

Outdoor cooking equipment of various kinds is known in the state of the art. Grills are frequently placed on top of charcoal fires to heat the food. However, it may be difficult to control the cooking process after sunset because there is no lighting provided to illuminate the food while cooking. To solve this problem, lamps have been placed in close proximity or have been mounted to the forehead of the cook. Sometimes, a cook is forced to hold a flashlight in his mouth. Yet, these solutions are clumsy.

U.S. Pat. No. 6,012,442 discloses a grill that has horizontal shelves attached to sidewalls. Food can be placed on the shelves for cooking. The heat is provided by charcoal from below. The cooking process can be viewed through a window and a transparent dome cover. The dome cover may be provided with a handle. A lighting assembly can be attached to the handle on the outside of the dome cover to illuminate the food through the dome cover.

The disadvantages of this solution are that this grill is not easy to carry around. Furthermore, the dome cover may become fogged or dirty. This keeps the light from reaching the food and may make it impossible to supervise the cooking by looking through the dome cover. Furthermore, in order to provide illumination the dome cover may not be removed.

The objective of the present invention is to provide a cooking device that may be comfortably carried around and used outdoors and that provides illumination of the goods to be heated.

### SUMMARY OF THE INVENTION

The present invention is directed to overcoming the problems set forth above by providing a foldable cooking device with the features of claim 1. Preferred embodiments of the invention are disclosed in the dependent claims 2 to 13.

The inventive foldable cooking device comprises a first partial shell; a second partial shell pivotably connected to the first partial shell via a hinge; a heating unit mounted to an inside of the first partial shell; and a lighting unit for illuminating the heating unit in the unfolded (or opened) state of the cooking device, the lighting unit being attached to an inside of the second partial shell, wherein the insides of the first partial shell and the second partial shell face each other in the folded state of the cooking device.

The inventive solution provides a cooking device that is easily foldable. Thus, it is small in size and can be carried around easily. In the unfolded state, a lighting unit is provided to illuminate the heating unit. The inventive device can he used for cooking in the dark. It is no longer necessary to provide other means for lighting the food or pots on the heating unit while cooking.

The heating unit may generate heat from electricity, gas, wood, charcoal or other suitable he ii means.

According to another aspect of the invention, the lighting unit is mounted to a distal end of the second partial shell. The distal end is opposite to the hinge. This ensures that lighting unit is positioned at a distance from the heating unit. Thus the lighting unit can illuminate a large surface area of the heating unit.

According to another aspect of the invention, the lighting unit is mounted to the second partial shell via a handle which extends through the second partial shell. Preferably, the lighting unit is detachably mounted to the handle. The lighting unit is thus attached to the ends of the handle that project through the second partial shell. This has the advantage that the second partial shell only has to have one or more apertures for inserting the handle. It is not necessary to provide threads or the like for attaching the lighting unit.

According to another aspect of the invention, a power source for the lighting unit is positioned in the handle. This solution makes optimal use of the available space, Thus the lighting unit can be very small.

According to another aspect of the invention, the handle is provided with an opening for exchanging the power source. The power source may be easily and quickly removed from the handle and a new one inserted. The power source is exchangeable even when cooking. The power source can be a battery that is rechargeable or disposable. The handle may also be provided with an electric socket.

According to another aspect of the invention, a switch for the lighting unit is provided on the handle. At this position, the switch may be easier to reach. It may also be shielded from the heat of the heating unit by the second partial shell.

According to another aspect of the invention, the lighting unit is attached to the second partial shell via at least one magnet. This solution facilitates the attachment and removal of the lighting unit. Also, the lighting unit may be attached to the inside of the second partial shell wherever it is most convenient and/or provides the best illumination results,

According to another aspect of the invention, the lighting unit comprises lighting means. The lighting means may be conventional light bulbs.

According to another aspect of the invention, the lighting means is a light emitting diode (LED). One of the advantages of LEDs is their efficiency. Also, LEDs last longer than conventional light bulbs.

According to another aspect of the invention, the lighting means is movably mounted to the lighting unit. This arrangement allows for adjustments of the direction the light is emitted from the lighting unit. In a preferred embodiment, the lighting means is pivotably mounted to the lighting unit.

According to another aspect of the invention, the lighting unit houses a clock. The clock allows for monitoring the cooking time.

According to another aspect of the invention, the clock comprises a timer. A count-down timer alerts the cook when a preset time has ended.

According to another aspect of the invention, the clock is provided with an alarm function. The alarm function sounds an alarm at a set time.

### BRIEF DESCRIPTION OF THE DRAWINGS

FIG. 1 is a perspective view of a foldable cooking device according to a first embodiment of the invention.

FIG. 2 is a perspective view of a foldable cooking device according to a second embodiment of the invention.

FIG. 3 is a perspective view of the lighting unit of FIG. 2.

### DETAILED DESCRIPTION OF THE PREFERRED EMBODIMENTS

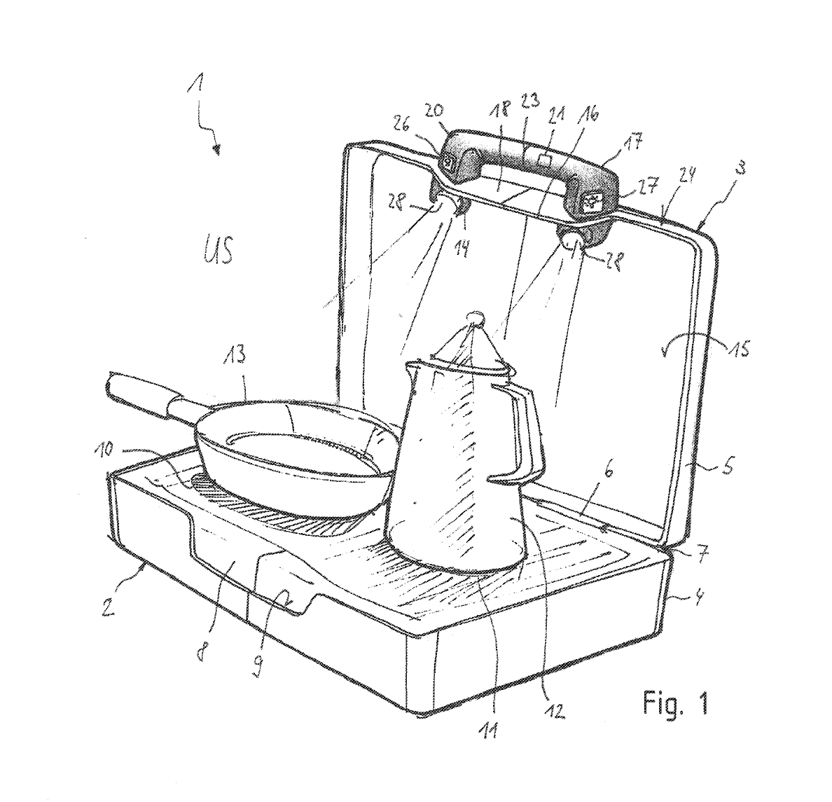

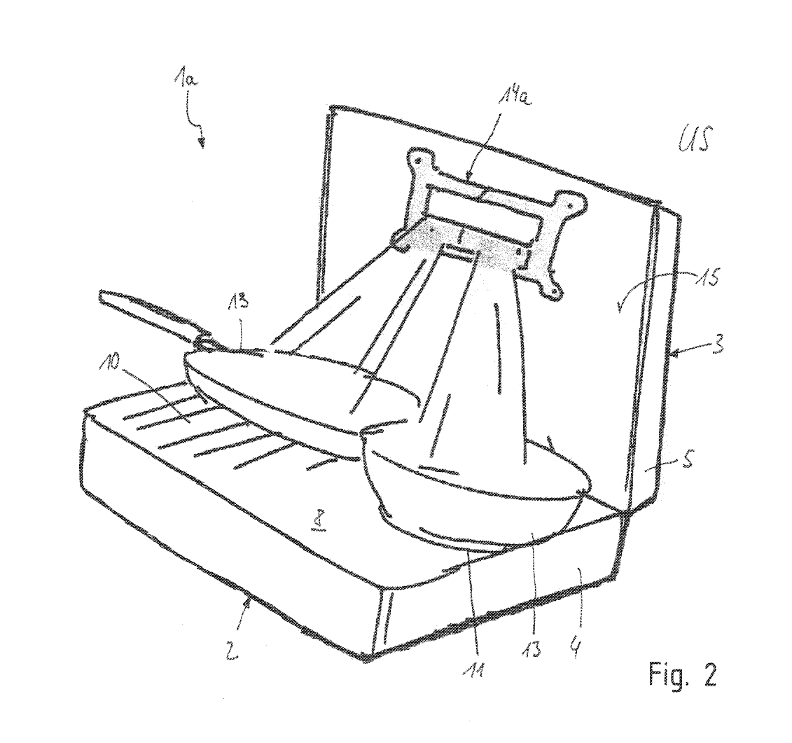

Referring to FIGS. 1 and 2, a foldable cooking device 1, 1a comprises a first partial shell 2 (or bottom shell) and a second partial shell 3 (or top shell). The shells 2, 3 are made of metal, preferably aluminum. The shells 2, 3 are provided with sidewalls 4, 5, The second partial shell 3 pivotably connected to the first partial shell 2 via a hinge 6 at the back 7 of the shells 2,3, A heating unit 8 is mounted to an inside 9 of the first partial shell 2. The heating unit 8 may be an electrical heating unit, a gas heating unit or a charcoal heating unit. In these embodiments the heating 8 unit comprises two hobs 10, 11. A pot 12 is placed on the right hob 11 and a pan 13 is placed on the left hob 10. The cooking device 1, 1a further comprises a lighting unit 14, 14a for illuminating the heating unit 8 in the unfolded state US (or opened state) of the cooking device 1, 1a. The lighting unit 14, 14a is attached to an inside 15 of the second partial shell 3, In FIG. 1 the lighting unit 14 is mounted at a distal end 16 thereof via a handle 17.

In both embodiments, the insides 9, 15 of the first partial shell 2 and the second partial shell 3 face each other in the folded state (not shown) of the cooking device 1, 1a. In the folded state the foldable cooking device 1 looks like a briefcase from the outside.

In FIG. 1, a front side wall 18 of the second partial shell 3 is provided with apertures. Mounting elements of the handle 17 extend through the apertures, The external part 20 of the handle 17 is hollow and houses a power source 21 which is a stack of batteries. The handle 17 further comprises an opening 23 to access the power source 21 when it needs to be exchanged. On the part 20 of the handle 17 that is positioned on the outside 24 of the second partial shell 3, there are two switches 26, 27 for turning the lighting unit 14 on and off. The lighting unit 14 is attached to the mounting elements. The lighting unit 14 comprises two lighting means 28 that are movably, preferably. pivotably, mounted in the lighting unit 14. The lighting means 28 are light emitting diodes. Halogen lamps could also be used as lighting means.

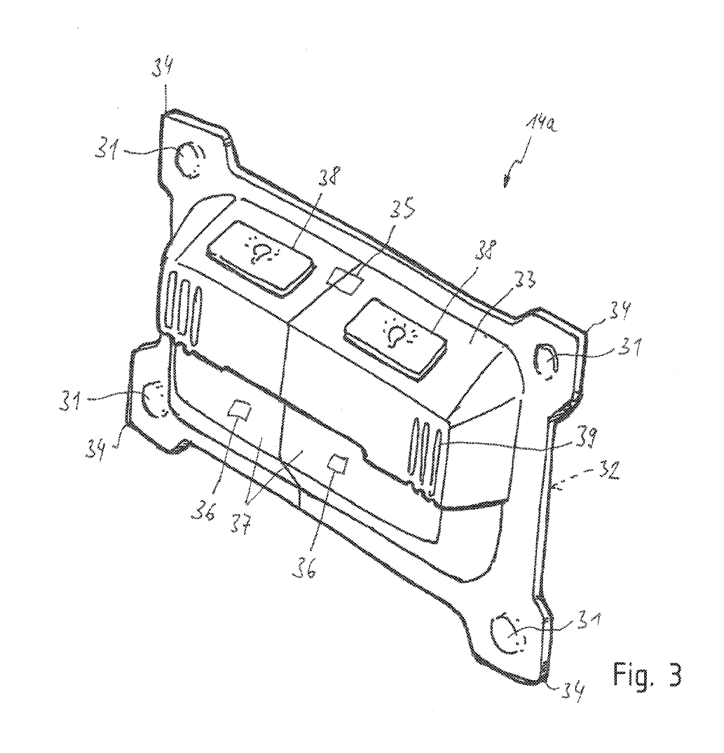

In FIGS. 2 and 3, the lighting unit 14a is attached to the second partial shell 3 via four magnets 31 that are attached to the reverse side 32 of a housing 33 of the lighting unit 14a at four corners 34. Therefore, the lighting unit 14a may be detached from the second partial shell 3 and re-attached at a different spot thereof. The lighting unit 14a houses a power source 35 and two lighting means 36, which in this case are conventional light bulbs. The lighting means 36 are protected by a transparent hood 37. Two switches 38 for turning the lighting means 36 on and off are projecting from the housing 33.

The lighting unit 14a of the second embodiment of the cooking device la further comprises a clock 39 with a timer and an alarm function.

### REFERENCE SIGNS

1—foldable cooking device
1a—foldable cooking device
2—first partial shell
3—second partial shell
4—sidewall
5—sidewall
6—hinge
7—back of 2, 3
8—heating unit
9—inside of 2
10—hob
11—hob
12—pot
13—pan
14—lighting unit
14a—lighting unit
15—inside of 3
16—distal end of 3
17—handle
18—front sidewall
20—external part of 17
21—power source
23—opening
24—outside of 3
26—switch
27—switch
28—lighting means
31—magnet
32—reverse side of 33
33—housing
34—corner
35—power source
36—lighting means
37—hood
38—switch
39—dock
US—unfolded state of 1, 1a

1. A foldable cooking device comprising:
a first partial shell;
a second partial shell pivotably connected to the first partial shell via a hinge;
a heating unit mounted to an inside of the first partial shell; and
a lighting unit for illuminating the heating unit in the unfolded state (US) of the cooking device, the lighting unit being attached to an inside of the second partial shell,
wherein the insides of the first partial shell and the second partial shell face each other in the folded state of the cooking device.

2. The cooking device of claim 1, wherein the lighting unit is mounted to a distal end of the second partial shell.

3. The cooking device of claim 1, wherein the lighting unit is mounted to the second partial shell via a handle which extends through the second partial shell.

4. The cooking device of claim 3, wherein a power source for the lighting unit is positioned in the handle.

5. The cooking device of claim 4, wherein the handle is provided with an opening for exchanging the power source.

6. The cooking device of claim 3, wherein a switch for the lighting unit is provided on the handle.

7. The cooking device of claim 1, wherein the lighting unit is attached to the second partial shell via at least one magnet.

8. The cooking device of claim 1, wherein the lighting unit comprises lighting means.

9. The cooking device of claim 8, wherein the lighting means is a light emitting diode.

10. The cooking device of claim 8, wherein the lighting means is movably mounted to the lighting unit.

11. The cooking device of claim 1, wherein the lighting unit houses a clock.

12. The cooking device of claim 11, wherein the clock comprises a timer.

13. The cooking device of claim 11, wherein the clock is provided with an alarm function.
